(19) United States
(12) Patent Application Publication
(10) Pub. No.: US 2015/0090193 A1
(43) Pub. Date: Apr. 2, 2015

(54) Multifunctional Tugging Dog Toy

(71) Applicant: Michael Giarrizzo, Huntington Station, NY (US)

(72) Inventor: Michael Giarrizzo, Huntington Station, NY (US)

(21) Appl. No.: 14/501,269

(22) Filed: Sep. 30, 2014

Related U.S. Application Data
(60) Provisional application No. 61/884,283, filed on Sep. 30, 2013.

(51) Int. Cl. A01K 11/00; A61D 5/00

(52) U.S. Cl. CPC A01K 15/026; A61D 5/00
USPC 119/709

(57) ABSTRACT

A dog toy is a multifunctional device that is utilized by a dog for entertainment, encouraging physical activity, and improving oral hygiene. The dog toy may be used as a chew toy and features a transparent chewable shell with at least one vibration-activated light-emitting diode (LED) assembly within that is activated upon shaking, throwing, or otherwise physically stimulating the dog toy. Emitted light is visible through the transparent chewable shell. The dog toy may additionally be used as a tug toy through the incorporation of a first tug handle and a second tug handle positioned at opposite ends of the dog toy. Finally, the dog toy may be used as a fetch toy as a human user may throw the dog toy for a dog to retrieve. The dog toy is capable of massaging a dog's gums during chewing as well as flossing the dog's teeth.

The current application claims a priority to the U.S. Provisional Patent application serial number 61/884,283 filed on Sep. 30, 2013.

### FIELD OF THE INVENTION

The present invention relates generally to a multifunctional device for use with a dog. More specifically, the present invention is a dog toy for entertaining a dog as well as improving the dog's oral hygiene and physical fitness.

### BACKGROUND OF THE INVENTION

Dog toys are commonly utilized for a variety of purposes ranging from providing entertainment to promoting exercise. Dog toys may often be played with by a dog independently, with other dogs, or with a human. One of the primary benefits offered by dog toys is entertainment as a dog that is kept interested and occupied by a dog toy is less likely to engage in problematic and disruptive behavior due to restlessness and boredom. Additionally, some types of dog toys provide health benefits in addition to the benefits of exercise. Chew toys are composed of latex and rubber and provide a healthy outlet for dogs to satisfy their natural biting instincts. Additionally, chewing on these chew toys allows dogs to keep their gums and teeth clean and healthy. Many dog toys provide multiple functions and means for dogs to interact with the toys. For example, several variants of dog toys may be thrown and retrieved during play as well as chewed on. A single dog toy may be played with by two or more dogs simultaneously as well. Due to the nature of their use, dog toys are subject to significant wear and tear. A dog toy must be well-designed and structurally integral as well as provide an extended lifetime of use for a dog without becoming compromised.

The present invention is a dog toy for providing a dog with entertainment as well as improved oral hygiene and physical fitness. The dog toy is multifunctional and may be enjoyed by one or two dogs simultaneously. A human user may utilize the dog toy to play with a dog as well. The dog toy encourages a dog to engage in physical activity, primarily by chasing the dog toy when thrown. Additionally, the dog toy is chewable and is capable of both massaging the dog's gums as well as flossing the dog's teeth.

### BRIEF DESCRIPTION OF THE DRAWINGS

FIG. 1 is a perspective view of the present invention.

FIG. 2 is a side view of the present invention.

FIG. 3 is a cross-sectional view of the transparent chewable shell displaying the internal components of the present invention.

FIG. 4 is a perspective view of an alternative embodiment of the present invention.

FIG. 5 is a schematic diagram of the electronic components of the present invention.

### DETAIL DESCRIPTIONS OF THE INVENTION

All illustrations of the drawings are for the purpose of describing selected versions of the present invention and are not intended to limit the scope of the present invention.

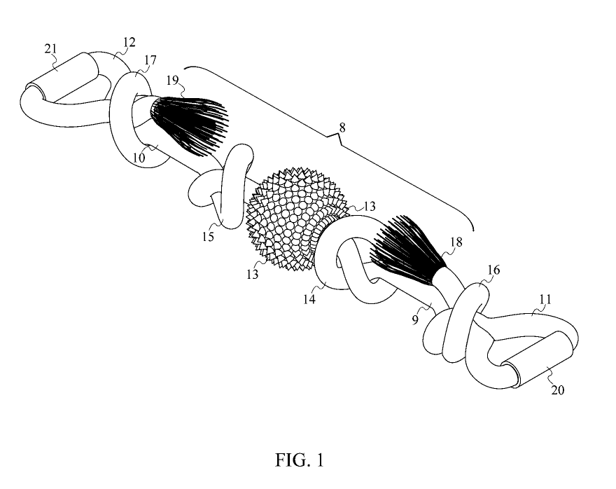

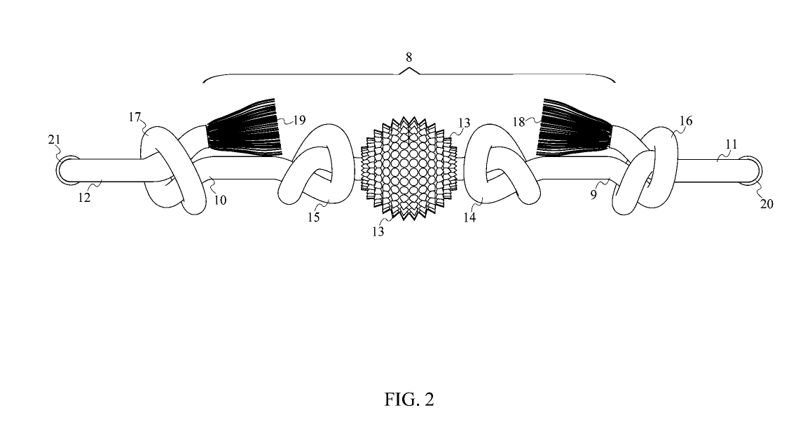

The present invention is a dog toy that is utilized to improve a dog's physical fitness and oral hygiene while providing entertainment as well. The present invention is shown in FIGS. 1-3. The present invention comprises a transparent chewable shell 1, a transparent protective casing 2, at least one vibration-activated light-emitting diode (LED) assembly 3, a straight portion of rope 8, a first looped portion of rope 11, and a second looped portion of rope 12. In a preferred embodiment of the present invention, the straight portion of rope 8, the first looped portion of rope 11, and the second looped portion of rope 12 form a single continuous length of rope. The transparent chewable shell 1 serves as an object that a dog may chew on while playing with the present invention. The transparent protective casing 2 is contained within the transparent chewable shell 1 and protects the at least one vibration-activated LED assembly 3 from potential damage due to the dog's chewing. The straight portion of rope 8 provides length to the present invention and thus allows the present invention to be used as a tug toy. The first looped portion of rope 11 and the second looped portion of rope 12 are positioned on opposite ends of the present invention and provide grasping points for both a dog and a human user.

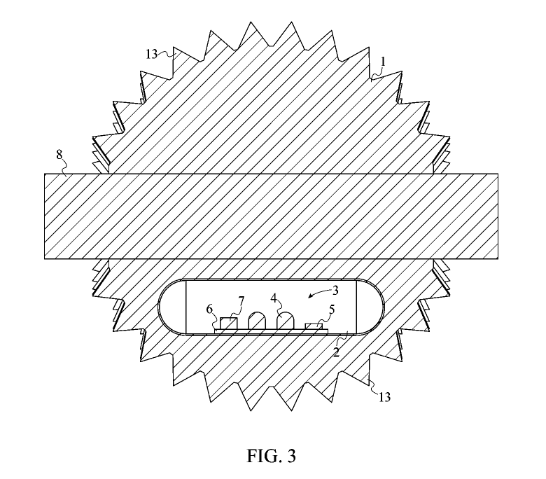

With reference to FIGS. 1-3, the straight portion of rope 8 traverses through the transparent chewable shell 1 in a manner such that the transparent chewable shell 1 is positioned at the midpoint of the straight portion of rope 8. The first looped portion of rope 11 is adjacently connected to the straight portion of rope 8. Similarly, the second looped portion of rope 12 is adjacently connected to the straight portion of rope 8, opposite to the first looped portion of rope 11. The first looped portion of rope 11 and the second looped portion of rope 12 are positioned opposite to each other on the straight portion of rope 8 in order to allow the present invention to be utilized as a tug toy. The transparent protective casing 2 is enclosed within the transparent chewable shell 1, adjacent to the straight portion of rope 8. The at least one vibration-activated LED assembly 3 is enclosed within the transparent protective casing 2 as shown in FIG. 3. The positioning of the transparent protective casing 2 within the transparent chewable shell 1 and the positioning of the at least one vibration-activated LED assembly 3 within the transparent protective casing 2 protects the at least one vibration-activated LED assembly 3 from potential damage caused by a dog chewing on the transparent chewable shell 1. Additionally, when activated, the light emitted by the at least one vibration-activated LED assembly 3 is visible from within the transparent protective casing 2 and the transparent chewable shell 1. The at least one vibration-activated LED assembly 3 may be activated upon the user shaking the present invention. The present invention may also be thrown in order to allow a dog to retrieve the present invention, such as during a game of fetch.

The present invention further comprises a plurality of flexible nubs 13. The plurality of flexible nubs 13 is capable of massaging and otherwise physically stimulating a dog's gums when the dog chews on the transparent chewable shell 1. The plurality of flexible nubs 13 is externally and spherically distributed about the transparent chewable shell 1. In alternative embodiments of the present invention, the transparent chewable shell 1 may feature a non-spherical design. Additionally, each of the plurality of flexible nubs 13 is tangentially connected to the transparent chewable shell 1. As such, the plurality of flexible nubs 13 completely covers the exterior of the transparent chewable shell 1 that comes into contact with a dog's gums while being chewed.

The present invention further comprises a first stopper 14 and a second stopper 15. The first stopper 14 and the second stopper 15 serve to maintain the transparent chewable shell 1 in place on the straight portion of rope 8. As such, the first stopper 14 is fixed adjacent to the transparent chewable shell 1 while the second stopper 15 is fixed adjacent to the transparent chewable shell 1, opposite to the first stopper 14. This allows the transparent chewable shell 1 to maintain its position on the straight portion of rope 8 and prevents the transparent chewable shell 1 from sliding along the straight portion of rope 8 as well. In an embodiment of the present invention, the first stopper 14 is a first inner knot along the straight portion of rope 8 while the second stopper 15 is a second inner knot along the straight portion of rope 8. Because the first stopper 14 and the second stopper 15 are positioned on opposite sides of the transparent chewable shell 1 along the straight portion of rope 8, the transparent chewable shell 1 is held in place and unable to move along the length of the straight portion of rope 8.

The present invention further comprises a first fastener 16 and a second fastener 17, which are used on a first end 9 and a second end 10 of the straight portion of rope 8. The first looped portion of rope 11 is connected to the first end 9 by the first fastener 16 while the second looped portion of rope 12 is connected to the second end 10 by the first fastener 16. In a preferred embodiment of the present invention, the first fastener 16 and the second fastener 17 tie off the opposite ends of the single continuous length of rope formed by the straight portion of rope 8, the first looped portion of rope 11, and the second looped portion of rope 12. In an embodiment of the present invention, the first fastener 16 is a first end knot between the straight portion of rope 8 and the first looped portion of rope 11. Similarly, the second fastener 17 is a second end knot between the straight portion of rope 8 and the second looped portion of rope 12. The first fastener 16 and the second fastener 17 are able to prevent the present invention from unraveling during use.

The present invention further comprises a first tassel 18 and a second tassel 19. The first tassel 18 is connected in between the first end 9 and the first looped portion of rope 11. Similarly, the second tassel 19 is connected in between the second end 10 and the second looped portion of rope 12. The first tassel 18 and the second tassel 19 may be taken into a dog's mouth and chewed, similar to the transparent chewable shell 1. The first tassel 18 and the second tassel 19 are able to serve as floss with the individual strands of the first tassel 18 and the second tassel 19 capable of cleaning between the dog's teeth as well as improving the dog's overall oral hygiene.

The present invention further comprises a first tug handle 20 and a second tug handle 21. The first tug handle 20 and the second tug handle 21 may be grasped by a human user of the present invention or by a dog's mouth. The first tug handle 20 is sleeved around the first looped portion of rope 11 while the second tug handle 21 is sleeved around the second looped portion of rope 12. The first tug handle 20 and the second tug handle 21 serve to facilitate grip and control over the opposing ends of the present invention when a dog or human user is utilizing the present invention. Additionally, the first tug handle 20 and the second tug handle 21 facilitate use of the present invention as a tug toy. In an embodiment of the present invention, the first tug handle 20 and the second tug handle 21 are rubberized and durable to withstand chewing and similar handling by a dog.

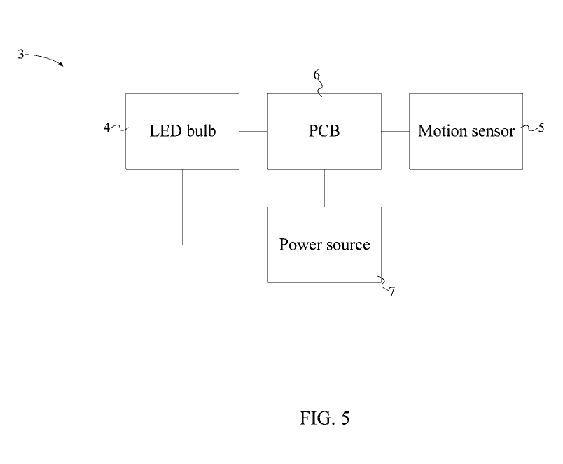

Again referring to FIG. 3, the at least one vibration-activated LED assembly 3 comprises an LED bulb 4, a motion sensor 5, a printed circuit board (PCB) 6, and a power source 7. The electronic connections between the components of the at least one vibration-activated LED assembly 3 are shown in FIG. 5. The LED bulb 4 provides light that is visible from the exterior environment through the transparent protective casing 2 and the transparent chewable shell 1. The motion sensor 5 is capable of detecting any movement and vibrations resulting from the present invention being shaken, thrown, or otherwise interacted with. The motion sensor 5 is electronically connected to the LED bulb 4 through the PCB 6. As such, the LED bulb 4 is able to activate and emit light based on movement and vibrations detected by the motion sensor 5. The power source 7 is electrically connected to the LED bulb 4, the motion sensor 5, and the PCB 6, providing power to the components of the at least one vibration-activated LED assembly 3.

The present invention is a multifunctional dog toy that may be utilized by one or more dogs simultaneously or by a dog and a human user simultaneously as well. As previously discussed, the present invention may be utilized as a chew toy, a fetch toy, and as a tug toy. The plurality of flexible nubs 13, the first tassel 18, and the second tassel 19 are able to improve a dog's oral hygiene through interaction with the present invention. The present invention may also be thrown for a dog to retrieve during a game of fetch. The light emitted by the at least one vibration-activated LED assembly 3 is activated upon the present invention being shaken or coming into contact with a surface after being thrown. The first tug handle 20 and the second tug handle 21 allow the present invention to be utilized as a tug toy. Because the first tug handle 20 and the second tug handle 21 are positioned at opposite ends of the present invention, the first tug handle 20 and the second tug handle 21 may be grasped in a human user's hand or in a dog's mouth in order to be utilized as a tug toy.

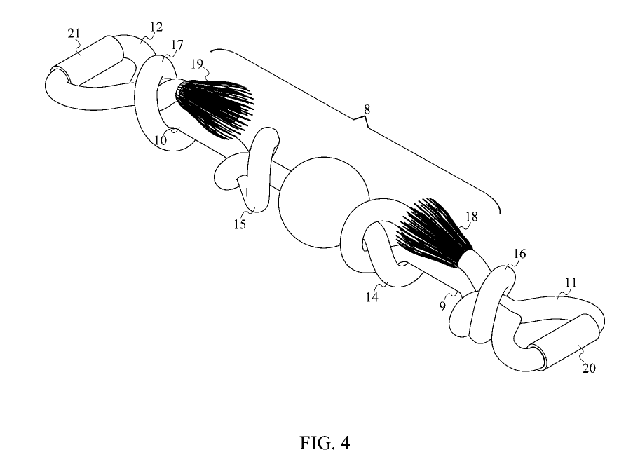

In an alternative embodiment of the present invention, the design of the transparent chewable shell 1 may vary. An example alternative embodiment of the present invention is shown in FIG. 4. In this alternative embodiment of the present invention, the plurality of flexible nubs 13 is not present on the transparent chewable shell 1 and the transparent chewable shell 1 is smooth. In further alternative embodiments of the present invention, the transparent chewable shell 1 may feature a non-spherical design as well. The present invention may additionally vary in terms of size to accommodate all sizes of dogs from small to large.

Although the invention has been explained in relation to its preferred embodiment, it is to be understood that many other possible modifications and variations can be made without departing from the spirit and scope of the invention as hereinafter claimed.

What is claimed is:

1. A multifunctional tugging dog toy comprises:
a transparent chewable shell;
a transparent protective casing;
at least one vibration-activated light-emitting diode (LED) assembly;
a straight portion of rope;
a first looped portion of rope;
a second looped portion of rope;
the straight portion of rope traversing through the transparent chewable shell;
the first looped portion of rope being adjacently connected to the straight portion of rope;
the second looped portion of rope being adjacently connected to the straight portion of rope, opposite to the first looped portion of rope;
the transparent protective casing being enclosed within the transparent chewable shell, adjacent to the straight portion of rope; and
the at least one vibration-activated LED assembly being enclosed within the transparent protective casing.

2. The dog toy as claimed in claim 1 further comprises:
a plurality of flexible nubs;
the plurality of flexible nubs being externally and spherically distributed about the transparent chewable shell; and
each of the plurality of flexible nubs being tangentially connected to the transparent chewable shell.

3. The multifunctional tugging dog toy as claimed in claim 1 further comprises:
a first stopper;
a second stopper;
the first stopper being fixed adjacent to the transparent chewable shell; and
the second stopper being fixed adjacent to the transparent chewable shell, opposite to the first stopper.

4. The multifunctional tugging dog toy as claimed in claim 3 further comprises:
the first stopper being a first inner knot along the straight portion of rope; and
the second stopper being a second inner knot along the straight portion of rope.

5. The multifunctional tugging dog toy as claimed in claim 1 further comprises:
a first fastener;
a second fastener;
the straight portion of rope comprises a first end and a second end;
the first looped portion of rope being connected to the first end by the first fastener; and
the second looped portion of rope being connected to the second end by the second fastener.

6. The multifunctional tugging dog toy as claimed in claim 5 further comprises:
the first fastener being a first end knot between the straight portion of rope and the first looped portion of rope; and
the second fastener being a second end knot between the straight portion of rope and the second looped portion of rope.

7. The multifunctional tugging dog toy as claimed in claim 1 further comprises:
a first tassel;
a second tassel;
the straight portion of rope comprises a first end and a second end;
the first tassel being connected in between the first end and the first looped portion of rope; and
the second tassel being positioned in between the second end and the second looped portion of rope.

8. The multifunctional tugging dog toy as claimed in claim 1 further comprises:
a first tug handle;
a second tug handle;
the first tug handle being sleeved around the first looped portion of rope; and
the second tug handle being sleeved around the second looped portion of rope.

9. The multifunctional tugging dog toy as claimed in claim 1 further comprises:
the at least one vibration-activated LED assembly comprises an LED bulb, a motion sensor, a printed circuit board (PCB), and a power source;
the motion sensor being electronically connected to the LED bulb through the PCB; and
the power source being electrically connected to the LED bulb, the motion sensor, and the PCB.

10. A multifunctional tugging dog toy comprises:
a transparent chewable shell;
a transparent protective casing;
at least one vibration-activated light-emitting diode (LED) assembly;
a straight portion of rope;
a first looped portion of rope;
a second looped portion of rope;
a plurality of flexible nubs;
the straight portion of rope traversing through the transparent chewable shell;
the first looped portion of rope being adjacently connected to the straight portion of rope;
the second looped portion of rope being adjacently connected to the straight portion of rope, opposite to the first looped portion of rope;
the transparent protective casing being enclosed within the transparent chewable shell, adjacent to the straight portion of rope;
the at least one vibration-activated LED assembly being enclosed within the transparent protective casing;
the plurality of flexible nubs being externally and spherically distributed about the transparent chewable shell; and
each of the plurality of flexible nubs being tangentially connected to the transparent chewable shell.

11. The multifunctional tugging dog toy as claimed in claim 10 further comprises:
a first stopper;
a second stopper;
the first stopper being fixed adjacent to the transparent chewable shell;
the second stopper being fixed adjacent to the transparent chewable shell, opposite to the first stopper;
the first stopper being a first inner knot along the straight portion of rope; and
the second stopper being a second inner knot along the straight portion of rope.

12. The multifunctional tugging dog toy as claimed in claim 10 further comprises:
a first fastener;
a second fastener;
the straight portion of rope comprises a first end and a second end;
the first looped portion of rope being connected to the first end by the first fastener;
the second looped portion of rope being connected to the second end by the second fastener;
the first fastener being a first end knot between the straight portion of rope and the first looped portion of rope; and
the second fastener being a second end knot between the straight portion of rope and the second looped portion of rope.

13. The multifunctional tugging dog toy as claimed in claim 10 further comprises:
a first tassel;
a second tassel;
the straight portion of rope comprises a first end and a second end;
the first tassel being connected in between the first end and the first looped portion of rope; and
the second tassel being positioned in between the second end and the second looped portion of rope.

14. The multifunctional tugging dog toy as claimed in claim 10 further comprises:
a first tug handle;
a second tug handle;
the first tug handle being sleeved around the first looped portion of rope; and
the second tug handle being sleeved around the second looped portion of rope.

15. The multifunctional tugging dog toy as claimed in claim 10 further comprises:
the at least one vibration-activated LED assembly comprises an LED bulb, a motion sensor, a printed circuit board (PCB), and a power source;
the motion sensor being electronically connected to the LED bulb through the PCB; and
the power source being electrically connected to the LED bulb, the motion sensor, and the PCB.

16. A multifunctional tugging dog toy comprises:
a transparent chewable shell;
a transparent protective casing;
at least one vibration-activated light-emitting diode (LED) assembly;
a straight portion of rope;
a first looped portion of rope;
a second looped portion of rope;
a plurality of flexible nubs;
a first stopper;
a second stopper;
a first tug handle;
a second tug handle;
the straight portion of rope traversing through the transparent chewable shell;
the first looped portion of rope being adjacently connected to the straight portion of rope;
the second looped portion of rope being adjacently connected to the straight portion of rope, opposite to the first looped portion of rope;
the transparent protective casing being enclosed within the transparent chewable shell, adjacent to the straight portion of rope;
the at least one vibration-activated LED assembly being enclosed within the transparent protective casing;
the plurality of flexible nubs being externally and spherically distributed about the transparent chewable shell;
each of the plurality of flexible nubs being tangentially connected to the transparent chewable shell;
the first stopper being fixed adjacent to the transparent chewable shell;
the second stopper being fixed adjacent to the transparent chewable shell, opposite to the first stopper;
the first stopper being a first inner knot along the straight portion of rope;
the second stopper being a second inner knot along the straight portion of rope;
the first tug handle being sleeved around the first looped portion of rope; and
the second tug handle being sleeved around the second looped portion of rope.

17. The multifunctional tugging dog toy as claimed in claim 16 further comprises:
a first fastener;
a second fastener;
the straight portion of rope comprises a first end and a second end;
the first looped portion of rope being connected to the first end by the first fastener;
the second looped portion of rope being connected to the second end by the second fastener;
the first fastener being a first end knot between the straight portion of rope and the first looped portion of rope; and
the second fastener being a second end knot between the straight portion of rope and the second looped portion of rope.

18. The multifunctional tugging dog toy as claimed in claim 16 further comprises:
a first tassel;
a second tassel;
the straight portion of rope comprises a first end and a second end;
the first tassel being connected in between the first end and the first looped portion of rope; and
the second tassel being positioned in between the second end and the second looped portion of rope.

19. The multifunctional tugging dog toy as claimed in claim 16 further comprises:
the at least one vibration-activated LED assembly comprises an LED bulb, a motion sensor, a printed circuit board (PCB), and a power source;
the motion sensor being electronically connected to the LED bulb through the PCB; and
the power source being electrically connected to the LED bulb, the motion sensor, and the PCB.
